(19) United States
(12) Patent Application Publication
(10) Pub. No.: US 2003/0160488 A1
(43) Pub. Date: Aug. 28, 2003

(54) Turning table assembly of seat for vehicle

(76) Inventors: Jin Hyuk Kim, Kyungju-city (KR); Hwa Sik Kim, Kyungju-city (KR)

Correspondence Address: JACOBSON HOLMAN PLLC, 400 SEVENTH STREET N.W., SUITE 600, WASHINGTON, DC, 20004, US

(21) Appl. No.: 10/135,766

(22) Filed: May 1, 2002

(30) Foreign Application Priority Data
Feb. 28, 2002 (KR) 2002-10761

(51) Int. Cl. F16M 13/00

(52) U.S. Cl. 297/344.22; 297/344.21

(57) ABSTRACT

The present invention relates to a turning table of a seat for a vehicle which includes a lower plate installed in a floor of a vehicle, a first slider installed on an upper surface of the lower plate, a turning plate rotatably supported by the first slider, a second slider installed on an upper surface of the turning plate, and an upper plate which is supported by the second slider and integrally fixed to the lower plate. The upper protrusion of the lower plate which supports the corner portions of the lower plate and the turning plate and the lower protrusion of the turning plate are engaged each other. The lower plate and the upper plate are stable fixed. The first and second sliders integrally form the connection portions between a plurality of the ball portions. In the present invention, in a state that the seat is stopped, it is possible to easily prevent a movement of the seat based on an engagement between the upper protrusion of the lower plate and the lower protrusion of the rotation plate. It is possible to easily installed the slider by simply placing one slider on the installation portion formed in the lower plate and the turning plate for thereby enhancing an assembling operation and decreasing the working time.

### BACKGROUND OF THE INVENTION

1. Field of the Invention

The present invention relates to a turning table of a seat in a turning apparatus which turns a seat installed in the interior of a vehicle, and in particular to a turning table assembly of a seat for a vehicle which is capable of preventing a vibration of a seat and integrally forming a slider installed in the interior for thereby enhancing a durability of a structure and an assembling ability and decreasing a work time.

2. Description of the Background Art

Generally, a seat for a vehicle includes a seat track which is forwardly and backwardly movable for being adapted to a body type of a vehicle rider, a height and angle adjusting apparatus for adjusting the height of a seat cushion and a slanted angle of a back of a seat, and a turning apparatus for turning a seat so that a vehicle rider seats in a side direction or in a back direction.

The turning apparatus of a seat is formed of a turning table and a locking apparatus. The turning table is installed below a seat cushion of a seat, and the locking apparatus is installed in a lateral side or a central portion of the turning table. Therefore, a turning state and fixing state of the turning table is implemented based on an operation of the locking apparatus.

The conventional turning tables are disclosed in the Japanese Laid -open Patent No. Hei 5-278506 and the Japanese Laid-open Patent No. Hei 6-87364. As shown in FIG. 10, a center portion of a lower plate 101 and a center portion of an upper plate 102 are integrally fixed using a bolt or by a welding method, respectively. A turning plate 103 is rotatably installed between an edge portion of the lower plate 101 and an edge portion of the upper plate 102.

A ball installation portion 101a is bent in an upper surrounding surface of a diameter center portion of the lower plate 101, and a ball escape prevention shoulder portion 101b is formed in one side of the ball installation portion 101a. A ball installation portion 103a is bent in a surrounding surface of an upper edge portion of the turning plate 103.

A plurality of balls 104 are installed in the ball installation portion 101a of the lower plate 101 and are arranged on the upper portion of the lower plate 101 in such a manner that the turning plate 103 is supported by the balls 104. A plurality of balls 105 are installed in the ball installation portion 103a of the turning plate 103 provided in the upper portion of the lower plate 101 and are arranged on the upper portion of the turning plate 103 in such a manner that the upper plate 102 is supported by the balls 105. The center portions of the lower plate 101 and the upper plate 102 are bolted or welded.

However, in the conventional turning table of the seat of the vehicle, since a plurality of balls are used as a slider, the ball installation portion which supports the balls and the ball escape prevention shoulder portion are additionally installed, so that the structure of the lower plate is complicated.

In the conventional art, when installing a plurality of the balls, since the balls are provided on the ball installation portion formed in the lower plate and the turning plate, the workability is decreased, and the work time is increased for thereby decreasing a work efficiency.

In addition, in the conventional art, in a state that the turning plate is fixed by a locking apparatus, since there is not a certain structure for supporting the edge portion of the turning plate, when the edge portion of the turning plate is installed in a lower surface of the seat, the load is concentrated in the edge portion of the turning plate, so that the edge portion of the turning plate may be transformed.

### SUMMARY OF THE INVENTION

Accordingly, it is an object of the present invention to provide a turning table assembly of a seat for a vehicle which overcomes the problems encountered in the conventional art.

It is another object of the present invention to provide a turning table assembly of a seat for a vehicle which is capable of preventing a vibration of a seat in a state the seat is fixed, enhancing a durability of a structure using an integral type slider structure and an assembling ability and decreasing a work time.

In order to achieve the above objects, there is provided a turning table assembly of a seat for a vehicle which includes a lower plate in which an upwardly protruded upper protrusion having a bent front end is formed in corner portions of the same, a first installation portion is bent in a surrounding surface between a center portion and an edge portion, wherein said lower plate is installed in a floor of a vehicle, a first slider in which a plurality of ball potions are connected each other by a connection portion for thereby forming a ring shape, wherein said first slider is installed in a first installation portion of the lower plate and includes an inner portion and a lower portion which are supported by a first installation portion of the lower plate, a turning plate in which a hole is formed in the center of the same for thereby forming a ring shape, a second installation portion is bent in a surrounding surface of a flat center portion, and a lower protrusion in which a front portion of the same is bent and is engaged with a front end of the upper protrusion of the lower plate is formed in a portion corresponding to the upper protrusion of the lower plate, wherein said turning plate is supported by an upper portion and outer portion of the first slider and is rotatable on the upper portion of the lower plate, a second slider in which a plurality of ball portions are connected by a connection portion for thereby forming a ring shape, wherein said second slider is installed in the second installation portion of the turning plate and includes an inner portion and lower portion supported by the second installation portion of the turning plate, and an upper plate in which the center portion of the same is connected with a center portion of the lower plate, wherein said upper plate is downwardly bent for being supported by an upper portion and outer portion of the second slider and is fixed or non-fixed by a locking apparatus which is installed in the turning plate and includes an edge portion installed on the upper portion of the turning plate in the turning table of a seat for a vehicle which is detachably fixed by a locking apparatus and is installed in a lower portion of a seat frame of a seat for a vehicle for thereby turning the seat in parallel with a floor of a vehicle.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a turning table and a seat frame of a seat for a vehicle according to the present invention;

FIG. 2 is a plan view illustrating a turning table of a seat for a vehicle according to the present invention;

FIG. 3 is a cross-sectional view taken along line A-A of FIG. 2;

FIG. 4 is a cross-sectional view taken along line B-B of FIG. 2;

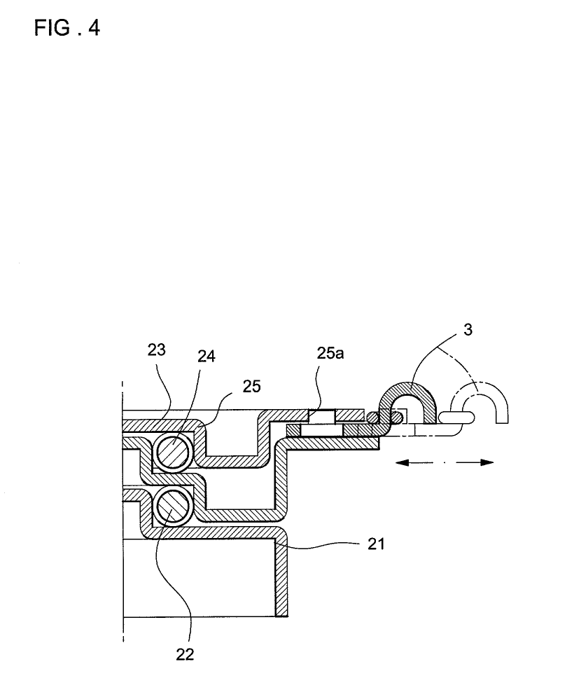

FIG. 5 is a cross-sectional view taken along line C-C of FIG. 2 according to one example of the present invention;

FIG. 6 is a cross-sectional view taken along line C-C of FIG. 2 according to another example of the present invention;

FIG. 7 is a plan view illustrating a slider adapted to a turning table of a seat for a vehicle according to an example of the present invention;

FIG. 8 is a plan view illustrating a slider adapted to a turning table of a seat for a vehicle according to another example of the present invention;

FIG. 9 is a perspective view taken by seeing a portion D of FIG. 1 from a rear side, which illustrates a structure for supporting a turning table of a seat for a vehicle according to the present invention; and

FIG. 10 is a cross-sectional view illustrating a part of a turning table of a seat for a vehicle in the conventional art.

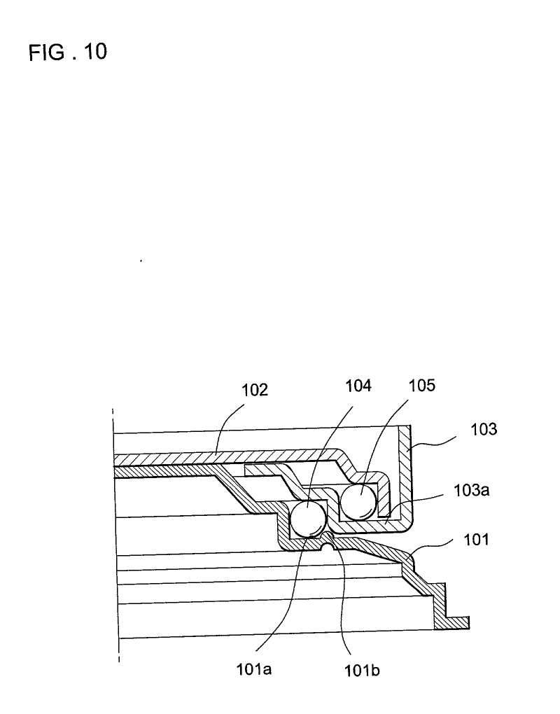

### DETAILED DESCRIPTION OF THE PREFERRED EMBODIMENTS

The embodiments of the apparatus for monitoring a radio frequency of a repeater according to the present invention will be described with reference to the accompanying drawings.

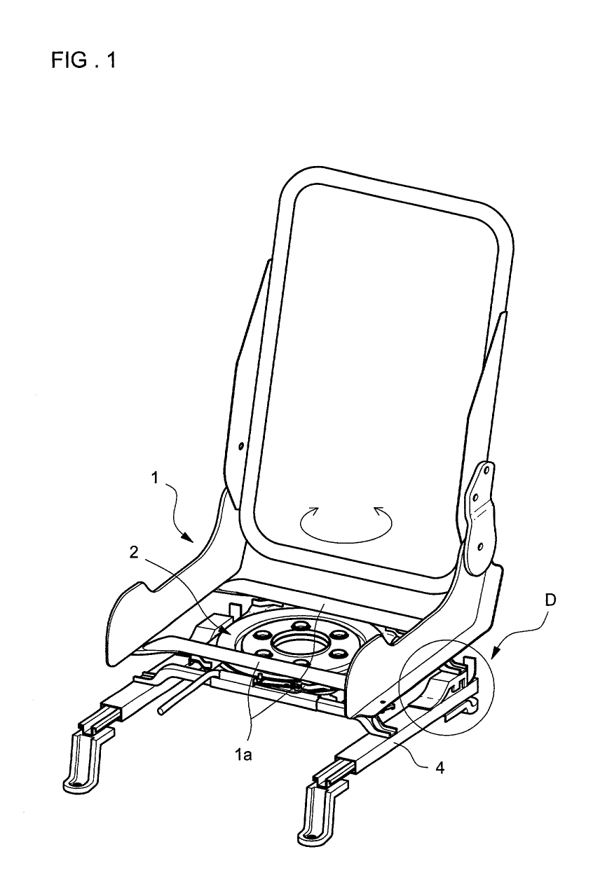

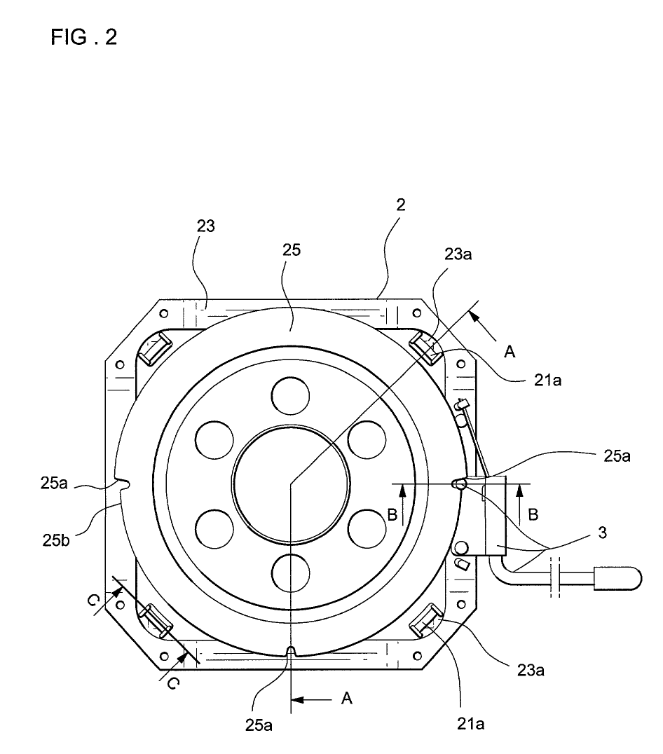

FIG. 1 is a view illustrating a seat frame to which a turning table of a seat for a vehicle is adapted according to the present invention. A turning table 2 is installed in a lower portion of a seat frame 1 of a vehicle according to the present invention. As shown in FIG. 2, a locking apparatus 3 is installed in a lateral surface of the turning table 2 for thereby fixing or non-fixing the turning table 2. A seat frame 1 which supports the seat for a vehicle is turned in parallel with respect to the floor of the vehicle.

The turning table of the seat for a vehicle according to the present invention may be installed between the seat frame 1 and the seat track 4.

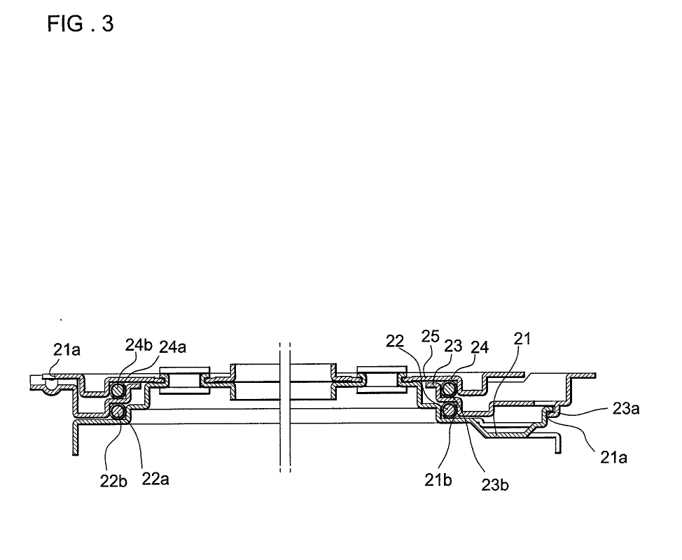

As shown in FIGS. 2 and 3, the turning table 2 of a seat for a vehicle includes a lower plate 21 installed in the floor of the vehicle, a first slider 22 installed in an upper surface of the lower plate 21, a turning plate 23 rotatably supported by the first slider 22, a second slider 24 installed in an upper surface of the turning plate 23, and an upper plate 25 supported by the second slider 24 and integrally fixed to the lower plate 21.

Here, an upper protrusion 21a is formed in a corner portion in such a manner that the lower plate 21 is upwardly protruded, and a front end of the same is outwardly bent. A first installation portion 21b is bent in a surrounding surface between the center portion and the edge portion for thereby supporting the inner and lower sides of the first slider 22.

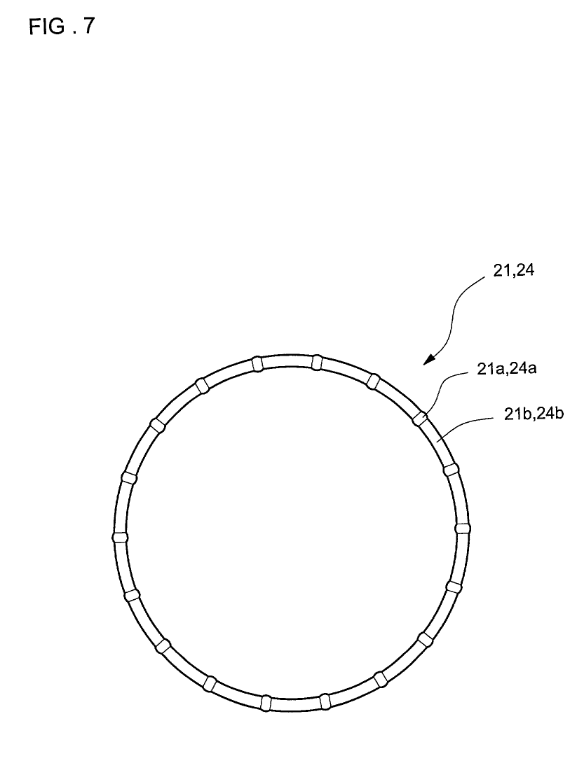

As shown in FIG. 7, the first slider 22 is formed in a ring shape in such a manner that a plurality of ball portions 22a are connected by a connection portion 22b, so that the ball portions 22a are protruded. The first slider 22 is installed in the first installation portion 21a of the lower plate 21, so that the inner and lower sides of the same are supported by the first installation portion 21a of the lower plate 21.

The turning plate 23 includes a hole in the center of the same and is formed in a ring shape. A lower protrusion 23a which is downwardly protruded and includes an inwardly bent front end for thereby being engaged with a front end of the upper protrusion 21a is formed in a portion corresponding to the upper protrusion 21a of the lower plate 21. A second installation portion 23b capable of supporting an outer portion and an upper portion of the second slider 24 is bent in a surrounding surface between the center portion and the edge portion and is supported by the upper portion and outer portion of the first slider 22, so that the second installation portion 23b is rotatable on the upper portion of the lower plate 21.

The turning plate 23 is installed in a lower portion of the lower frame la provided in the lower portion of the seat frame 1.

The second slider 24 is formed in the same shape as the first slider 22 and is installed in the second installation portion 23b of the turning plate 23 and includes an inner portion and lower portion supported by the second installation portion 23b.

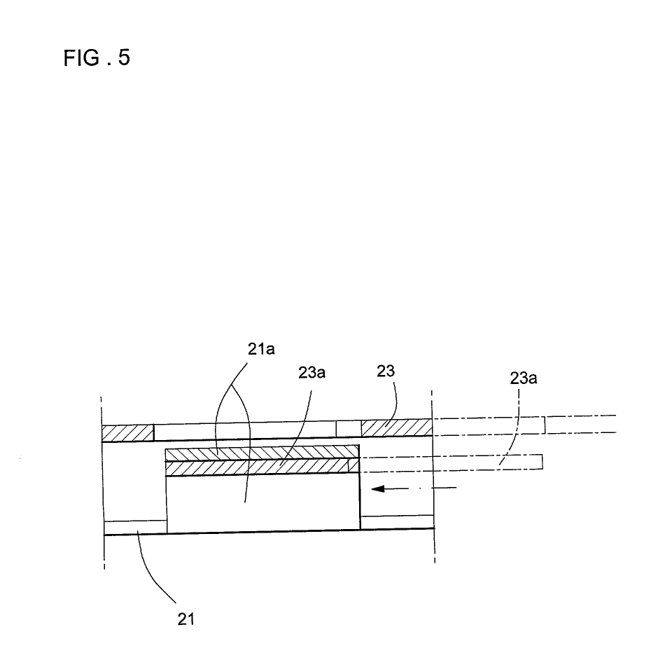

In the upper plate 25, the center portion of the same is connected with the center portion of the lower plate 21. The upper plate 25 is downwardly bent in such a manner that the upper plate 25 is supported by the upper and outer portions of the second slider 24, so that the edge portion of the same is installed in the upper portion of the turning plate 23. As shown in FIGS. 2, 3 and 5, three locking grooves 25a each having an inner angle of 90° are formed in the surrounding surface in such a manner that three locking grooves 25a are fixed or non-fixed by the locking apparatus 3 installed in the turning plate 23. A guide groove 25b communicates with the locking groove 25a and guides the locking apparatus 3.

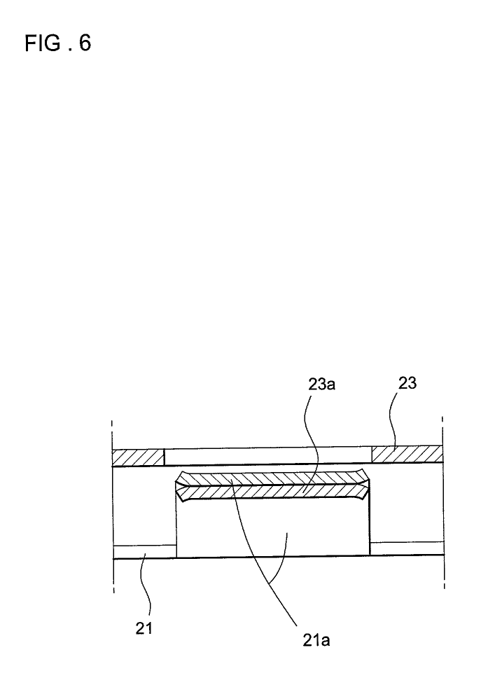

An efficient turning operation of the turning plate 23 is implemented by bending one of both sides of the front end of the upper protrusion 21a of the lower plate 21 and both sides of the front end of the lower protrusion 23a of the turning plate 23 at a certain slanted angle in a direction that the both sides of the front portions of the same are distanced from each other. As shown in FIG. 6, both sides of the front end of the upper protrusion 21a of the lower plate 21 may be upwardly bent, and both sides of the front end of the lower protrusion 21a of the turning plate 23 may be downwardly bent.

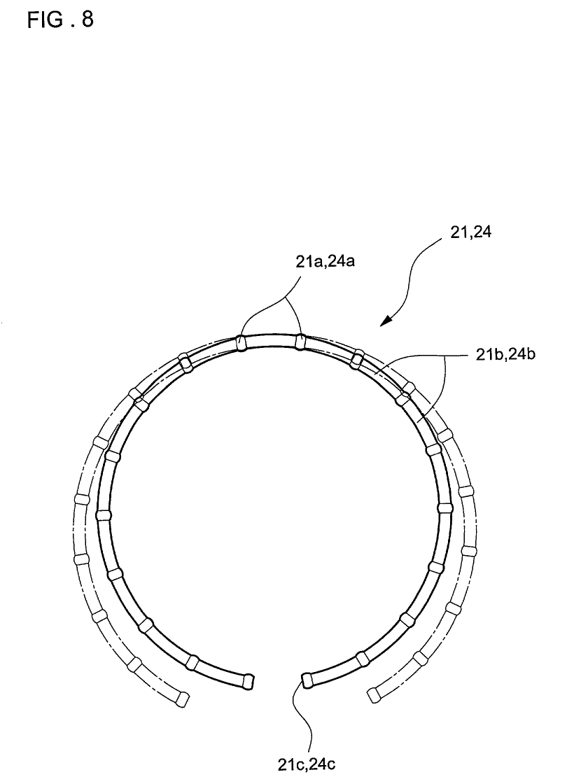

As shown in FIG. 8, in another example of the first slider 22 and the second slider 24 which are formed based on a plurality of ball portions and connection portions, openings 22c and 24c are formed by cutting one among a plurality of connection portions. Therefore, it is possible to implement an easier installation by changing the diameter even when the diameter of the first installation portion 21b of the lower plate 21 and the diameter of the second installation portion 23b of the turning plate 23 are slightly different. In the first slide 22 and the second slide 24, the inner angle between the ball portions and the neighboring ball portions, namely, the inner angle between the ball portions, the center and the neighboring ball portion is preferably 10°˜30°.

In the case that the inner angle is smaller than 10°, since the number of the ball portions is too large, the contacting surface is increased, so that it is impossible to implement a smooth sliding operation. In the case that the inner angle is larger than 30°, since the size of the weight applied to one ball portion is increased, the life span is decreased.

In the turning table of the seat for a vehicle, one slider 22, 24 formed of the ball portions 22a and 24a and the connection potions 22b and 24b is simply placed on the installation portions 21b and 23b formed in the lower plate 21 and the turning plate 23 for thereby implementing an installation operation.

In the present invention, it is possible to easily install the turning table of the seat for a vehicle. The turning table of the seat for a vehicle operates the locking apparatus 3 and unlocks the locked state of the upper plate 25, so that the turning plate 23 is rotated in a lateral direction or backward direction.

At this time, the sliders 22, 24 are installed in the lower surface and upper surface of the turning plate 23, so that it is possible to implement an easier turning operation with a lower friction and noise. After the turning operation, the locking apparatus 3 is operated for thereby fixing the turning plate 23.

Since the lower plate 21 and the upper plate 25 are fixed by a butting method without any gap therebetween, the movement of the turning plate 23 is prevented, and since the upper protrusion 21a of the lower plate 21 and the lower protrusion 23a o the upper plate 23 are engaged, the turning plate 23 is directly fixed or is fixed using the locking apparatus 3 after rotating the same at 90° or 180°. Therefore, the seat frame 1, namely, the seat is fixed without any movement. Even when a weight generated by a rider on the seat and a vibration of the vehicle is increased, since the weight is supported by the upper protrusion 21a and the lower protrusion 23a formed in the corner portions of the turning plate 23, the turning plate 23 is not transformed.

In the present invention, since the upper protrusion 21a formed in the lower plate 21 and the lower protrusion 23a formed in the turning plate 23 are engaged each other, in a state that a rider is on the seat, when the vehicle collides with a certain object, the structure of the same may be damaged.

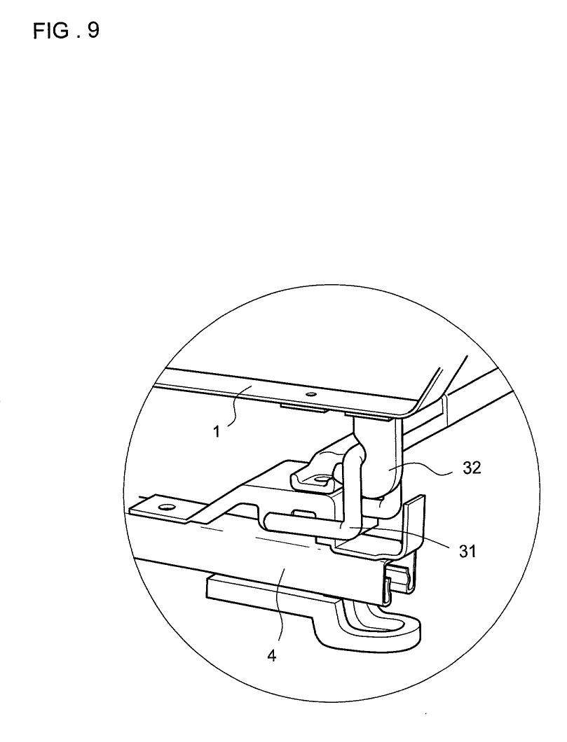

As shown in FIG. 9, in the present invention, a ring 31 is installed in an upper portion of the seat track 4 formed in the lower portion of the turning table 1, and a hook 32 which is detachable from the ring 31 is installed in one side of the lower corner portion of the seat frame 1.

When a driver drives the vehicle in a proper position, the hook 31 is hooked to the ring 32. When the vehicle collides with a certain object, the ring 32 and the hook 31 are disconnected and transformed, so that a force applied between the upper protrusion 21a formed in the lower plate 21 and the lower protrusion 23a formed in the turning plate 23 is decreased for thereby preventing a destruction of the same.

In the present invention, the turning table of a seat for a vehicle is installed in a lower portion of the seat of the vehicle for thereby implementing a smooth turning of the seat and preventing a movement. The turning table of the same is installed on the upper portion of the seat track of the seat for a vehicle capable of forwardly and backwardly moving the seat.

As described above, in a state that the seat is stopped, in the turning table of a seat for a vehicle according to the present invention, since the upper protrusion of the lower plate and the lower protrusion of the turning plate are engaged each other, the structure is simple and stable. The movement of the seat is prevented by preventing the movement of the turning plate. Even when a weight is largely applied in the upper direction of the turning plate, since the corner portion of the turning plate are supported, it is possible to easily prevent a transformation of the turning plate.

In addition, in the present invention, since the slider is formed of the connection portions integrally with a plurality of ball portions, it is possible to install the slider by simply placing one slider on the installation portion formed in the lower plate and the turning plate for thereby decreasing an assembling time and implementing an easier assembling operation. The workability is enhanced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a turning table of a seat for a vehicle which is detachably fixed by a locking apparatus and is installed in a lower portion of a seat frame of a seat for a vehicle for thereby turning the seat in parallel with a floor of a vehicle, a turning table of a seat for a vehicle, comprising:
a lower plate in which an upwardly protruded upper protrusion having a bent front end is formed in corner portions of the same, a first installation portion is bent in a surrounding surface between an center portion and an edge portion, wherein said lower plate is installed in a floor of a vehicle;
a first slider in which a plurality of ball potions are connected each other by a connection portion for thereby forming a ring shape, wherein said first slider is installed in a first installation portion of the lower plate and includes an inner portion and a lower portion which are supported by a first installation portion of the lower plate;
a turning plate in which a hole is formed in the center of the same for thereby forming a ring shape, a second installation portion is bent in a surrounding surface of a flat center portion, and a lower protrusion in which a front portion of the same is bent and is engaged with a front end of the upper protrusion of the lower plate is formed in a portion corresponding to the upper protrusion of the lower plate, wherein said turning plate is supported by an upper portion and outer portion of the first slider and is rotatable on the upper portion of the lower plate;
a second slider in which a plurality of ball portions are connected by a connection portion for thereby forming a ring shape, wherein said second slider is installed in the second installation portion of the turning plate and includes an inner portion and lower portion supported by the second installation portion of the turning plate; and
an upper plate in which the center portion of the same is connected with a center portion of the lower plate, wherein said upper plate is downwardly bent for being supported by an upper portion and outer portion of the second slider and is fixed or non-fixed by a locking apparatus which is installed in the turning plate and includes an edge portion installed on the upper portion of the turning plate.

2. The table of claim 1, wherein said first slider and second slider each include a diameter which is variable by cutting one connection portion.

3. The table of either claim 1 or claim 2, wherein an inner angle between a ball portion and a neighboring ball portion is 10°˜30° in the first and second sliders.

4. The table of claim 1, wherein more than one among both sides of a front end of an upper protrusion of the lower plate and both sides of a front end of the lower protrusion of the turning plate is bent at a certain slanted angle in a direction that said both are distanced from each other.

5. The table of claim 1, further comprising:
a ring installed in an upper portion of the seat track; and
a hook installed in a lower corner portion of the seat frame and being detachable from the ring.
